(19) United States
(12) Patent Application Publication
(10) Pub. No.: US 2006/0185492 A1
(43) Pub. Date: Aug. 24, 2006

(54) Shoulder bushing for saw blades

(76) Inventor: Francois Chianese, Cosnes et Romain (FR)

Correspondence Address: Richard L. Sampson;Sampson & Associates, 50 Congress Street, Boston, MA, 02109, US

(21) Appl. No.: 11/060,931

(22) Filed: Feb. 18, 2005

(51) Int. Cl. B26D 1/143

(52) U.S. Cl. 83/666; 83/698.41

(57) ABSTRACT

A shoulder bushing is provided for concentrically fastening a circular saw blade having an oversized mounting aperture, to a spindle of a rotary power tool. The bushing includes a disk having a central bore sized and shaped for concentric engagement with the spindle. An annular shoulder located on one side of the disk has an outer diameter sized for receipt within the oversized central aperture of the saw blade. The disk is provided with an outer diameter large enough to be engaged by a concave flange disposed on the spindle, by which the disk is clamped to the spindle in superposed orientation with the saw blade.

### BACKGROUND

1. Technical Field

This invention relates to saw blade equipment, and more particularly to shoulder bushings for concentrically mounting circular saw blades onto the spindles of rotary power tools.

2. Background Information

Power saws of the type that utilize circular saw blades come in a variety of sizes, and are produced and sold by many manufacturers. Although these power tools tend to be similar in many respects, distinctions are also present, not the least of which is the size of the spindle on which the saw blades are mounted. As a result, a user must be careful to purchase a saw blade having a central aperture that is properly sized for the particular make and model of power tool onto which the blade is to be installed. Oftentimes, however, the user inadvertently purchases a blade having a central aperture size that does not fit the user's machine. Or, the user may simply wish to remove a blade from one tool and reinstall it on another tool, only to find that the aperture of the blade is too large for the spindle of the other tool.

Attempts to mount such saw blades onto relatively undersized spindles leaves a gap between the aperture and the spindle which disadvantageously enables the saw blade to move radially relative to the spindle. Such radial movement tends to generate eccentric rotation (e.g., ‘running untrue’) of the blade during operation, which may result in inaccurate cutting and potential danger to the user.

A potential solution to this problem includes the use of reduction rings placed between the aperture and the spindle to effectively reduce the aperture size and prevent the blade from running untrue during operation. The blade may be secured to the spindle in a conventional manner, e.g., by the use of opposed circular flanges disposed on the spindle, which are tightened towards one another to capture both the saw blade and the reduction ring(s) therebetween.

The opposed flanges are typically concavo-convex or dish shaped, to engage the blade radially outward of its aperture. Thus, the reduction ring(s) may not be tightly engaged by the flanges. Unfortunately, this may permit the reduction ring to move axially out of the aperture during use. Once such axial movement has occurred, only the friction forces applied by the flanges serve to maintain the blade in concentric orientation with the spindle. In the event these forces are exceeded, the blade moves radially and becomes eccentric to the spindle. This eccentricity may lead to inaccurate cutting and to the possibility of the blade becoming damaged and injuring the operator.

Thus, a need exists for a device and method for securely attaching saw blades to spindles of power tools that addresses the aforementioned drawbacks.

### SUMMARY

An aspect of the invention includes a saw blade assembly for concentrically fastening a circular saw blade having a relatively oversized central aperture, to a spindle of a rotary power tool. The assembly includes the circular saw blade engaged with a bushing. The bushing includes a disk having a central bore engaged with the spindle to substantially maintain concentricity of central bore with the spindle during operational rotation. An annular shoulder on a side of the disk is received within the central aperture of the saw blade to maintain concentricity of the saw blade with the spindle. The blade and the disk are clamped in superposed orientation with one another between a pair of flanges disposed on the spindle.

Another aspect of the invention includes a bushing for concentrically fastening a circular saw blade having a relatively oversized central aperture, to a spindle of a rotary power tool. The bushing includes a disk having a central bore sized and shaped for engagement with the spindle to maintain concentricity of the central bore with the spindle during operational rotation thereof. An abutment on one side of the disk is sized and shaped for receipt within a correspondingly sized and shaped recess of the saw blade to maintain concentricity of the saw blade with the spindle during operation. The disk is configured for being engaged by a flange disposed on the spindle, to clamp the disk on the spindle in superposed orientation with the saw blade.

A further aspect of the invention includes a method of securing a saw blade onto a spindle of a rotary power tool. The method includes inserting the shoulder of the aforementioned bushing into a central aperture of a circular saw blade, placing the saw blade-bushing assembly onto the spindle of the power tool between opposing flanges, tightening the flanges towards one another so that the assembly is secured on the machine shaft.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a plan view of a circular saw blade with which an embodiment of the present invention is installed;

FIG. 2 is a cross sectional view, on an enlarged scale, taken along 2-2 of FIG. 1;

FIG. 3 is an exploded perspective view of the assembly of FIGS. 1 and 2; and

FIG. 4 is a view similar to that of FIG. 2, on a further enlarged scale, of an alternate embodiment of the shoulder bushing of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

Briefly, an embodiment of the present invention includes a shoulder bushing (also known as an adapter ring) 1 configured to maintain a circular saw blade 5 having an oversized central aperture 2, in concentric orientation with a spindle 6 of a power tool, e.g., a power saw (not shown).

Bushing 1 includes a disk portion 10 having a central bore 12 sized and shaped for concentric engagement with spindle 6 (e.g., with a conventional sliding or press fit) to nominally prevent bushing 1 from appreciably running untrue or otherwise moving radially relative to the spindle during operation.

The bushing also includes an abutment, which in the embodiment shown, takes the form of an annular shoulder 3 sized for concentric (e.g., sliding or press fit) receipt within central aperture 2 of the saw blade.

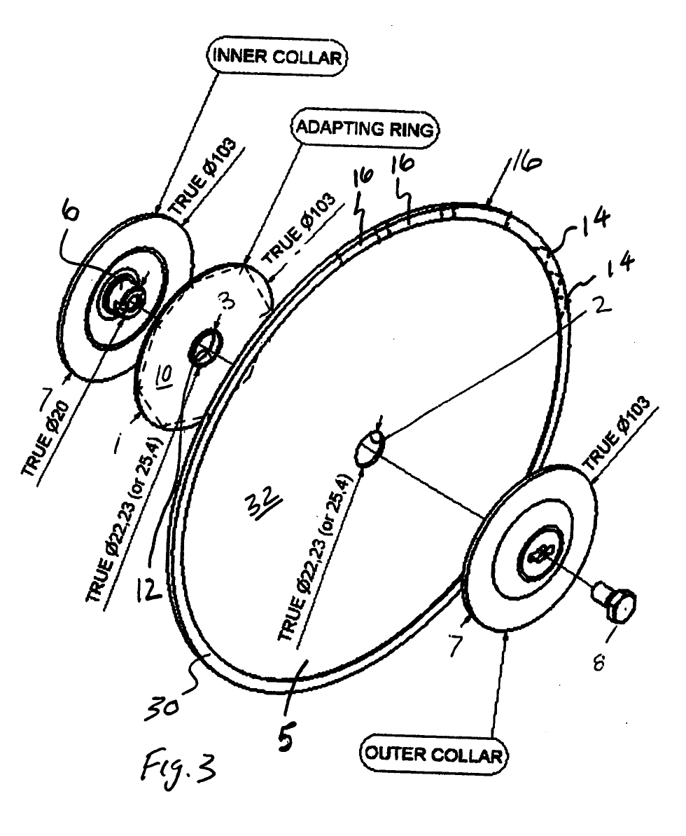

When installed, as best shown in FIG. 2, disk portion 10 extends radially outward in superposition with saw blade 5. Disk portion 10 extends sufficiently radially outward to permit the disk portion to be securely clamped against saw blade 5 by conventional concavo-convex flanges 7 of the power tool as shown.

Where used in this disclosure, the term “axial” when used in connection with an element described herein, refers to a direction relative to the element, which is substantially parallel to its center of rotation (e.g., axis a) when the element is installed on a spindle such as shown in FIG. 2. Similarly, the term “transverse” refers to a direction other than substantially parallel to the axial direction. The terms “transverse cross-section”, “transverse circumference” or “transverse dimension” refer to a cross-section, circumference, or dimension, respectively, taken along a transverse plane.

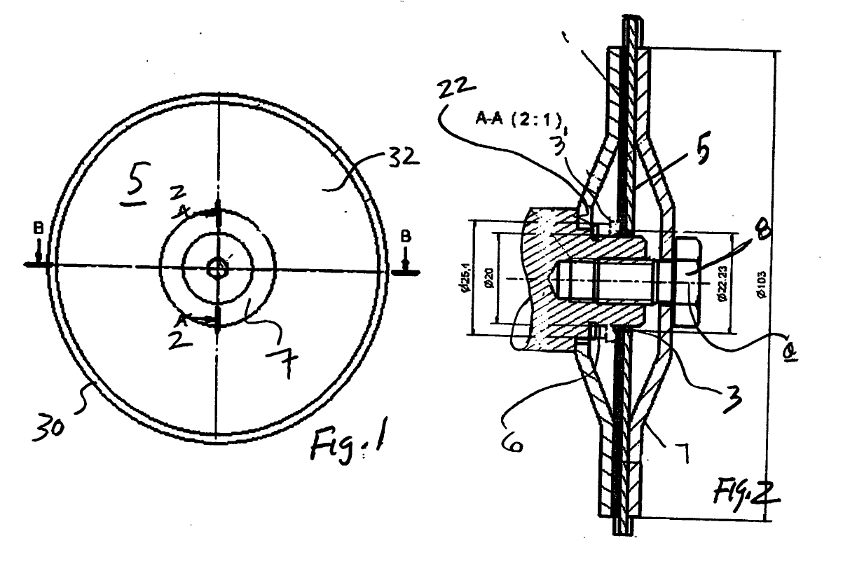

Referring to FIGS. 1-4, embodiments of the present invention will be discussed in detail. As best shown in FIGS. 1 and 3, embodiments of the present invention may be used with substantially any type of circular blade 5 known to those skilled in the art. For convenience, blade 5 is shown as an abrasive cutting disk/saw blade having a substantially smooth periphery. However, the skilled artisan will recognize that blade 5 may be provided with a plurality of cutting teeth (such as shown in phantom at 14 in FIG. 3) or with conventional segments (such as shown in phantom at 16 in FIG. 3) spaced along its circumference. Examples of saw blades/cutting wheels suitable for use with embodiments of the present invention include a diamond abrasive saw blade disclosed in U.S. Patent Publication No. US2004/019114 to Saint-Gobain Abrasives, Inc., and an abrasive cutting wheel disclosed in U.S. Pat. No. 5,313,742, assigned to Norton Company of Worcester, Mass., both of which are fully incorporated by reference herein.

Embodiments of the present invention may be particularly useful in combination with superabrasive (e.g., diamond) saw blades, such as those used to cut concrete, asphalt and other hard materials. Examples of such saw blades include those having a continuous superabrasive-laden rim 30 adhered to the perimeter of a circular steel core 32 as shown in FIGS. 1 and 3. Other exemplary superabrasive saw blades include superabrasive-laden segments 16 (FIG. 3) spaced along the periphery thereof.

Superabrasives such as diamond and cubic boron nitride (CBN) have been widely used on saws, drills, and other tools to cut, form or polish other hard materials. These tools are particularly useful in applications where other tools lack the strength and durability to be practical substitutes. For example, diamond saws are routinely used in the stone cutting industry due to their hardness and durability.

These superabrasive tools are typically manufactured by mixing superabrasive particles with a suitable matrix (bond) powder. The mixture is then compressed in a mold to form the desired shape (e.g., a segment 16 or rim 30). The “green” form is then consolidated by sintering at a suitable temperature to form a single body with a plurality of superabrasive particles disposed therein. The consolidated body or segment is attached (e.g., by brazing or laser welding) to a tool body, such as to the round core 32 of a circular saw, to form the final product.

In the alternative, these superabrasive tools may be manufactured with a continuous abrasive rim by brazing, electroplating, or electroforming a layer of abrasive grain onto the outer perimeter of the tool body or core to form the saw blade.

As discussed above, these superabrasive blades are intended for relatively difficult cutting operations. These operations thus tend to generate high stresses in the blades. As such, any eccentricity in the rotation of these blades during cutting would tend to increase these stresses, possibly to the point of dislodging the abrasive segments from the core. For this reason, embodiments of the present invention may be particularly useful in combination with superabrasive saw blades to help prevent eccentric rotation thereof during such relatively stressful cutting operations.

Referring to FIGS. 2 and 3, embodiments discussed herein are configured for use with conventional power saws, which typically use a pair of concavo-convex flanges 7 to fasten the blades 5 to a spindle 6.

As best shown in FIG. 2, the diameter of aperture 2 is substantially greater than that of spindle 6. Bushing 1 compensates for this mismatch of diameters by the aforementioned annular shoulder 3 disposed therebetween. As also shown, flanges 7, due to their conventional concave configuration, do not directly engage the shoulder 3. Rather, the shoulder is maintained in proper position between the spindle 6 and aperture 2 by disk portion 10 of the bushing. The disk portion is secured in superposed relation to saw blade 5 by peripheral portions of opposed flanges 7. In the embodiment shown, flanges 7 are secured in a conventional manner, such as by use of a threaded fastener 8 that threadably engages spindle 6 to capture the flanges between a head of the fastener and a shoulder 22 of the spindle.

The skilled artisan should recognize that substantially any type of fastener or fastening means may be used to secure flanges 7 to the spindle. Moreover, although spindle 6 has a circular transverse cross-section as shown, embodiments of the invention may accommodate spindles of substantially any cross-sectional geometry, e.g., rectangular, diamond, square, etc. Such embodiments would be provided with a central bore similarly sized and shaped to receive the spindle. The shoulder may be similarly sized and shaped to accommodate blades having central apertures of non-circular shapes.

Particular embodiments of the present invention may be fabricated from steel, using conventional fabrication techniques, such as machining, molding or forging operations. However, those skilled in the art will recognize that substantially any materials having sufficient structural integrity may be used. For example, metals such as aluminum, bronze, titanium, steel, and alloys and combinations thereof, may be used. In addition, it is contemplated that non-metallic materials, such as polymers and/or carbon or glass fiber reinforced composites, may be used without departing from the spirit and scope of the present invention.

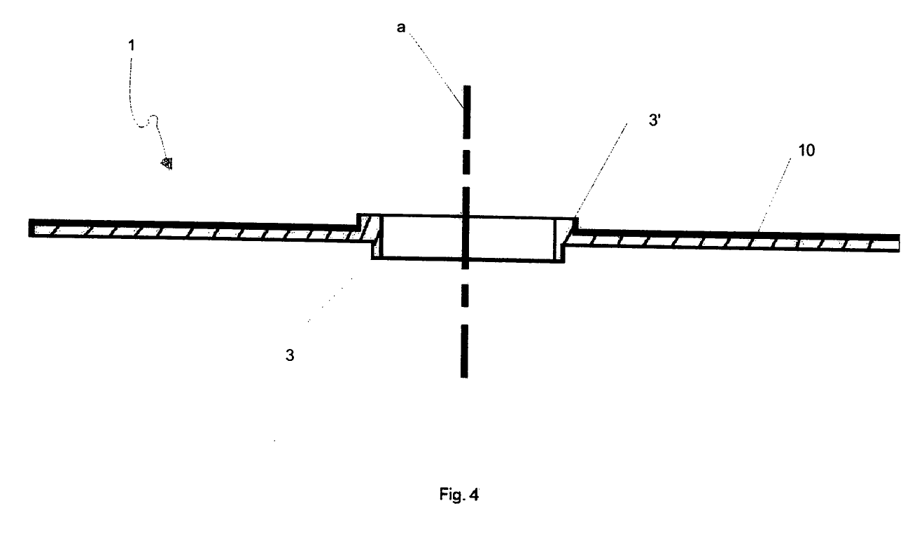

An alternate embodiment of the present invention shown as bushing 1′ in FIG. 4 and in phantom in FIG. 2, includes the aforementioned bushing 1 which has been provided with an optional shoulder 3′ disposed on the opposite side of disk portion 10 from shoulder 3. This other shoulder 3′ may be provided with an exterior size and/or shape distinct from that of shoulder 3. For example, shoulder 3′ may be sized and shaped for receipt within a central aperture larger in diameter than that of saw blade 5. This alternate embodiment thus provides a single device capable of adapting saw blades of two distinct aperture sizes to the spindle. Blades having a first aperture configuration (e.g., diameter) may be installed as shown in the Figures, while blades having a second aperture configuration may be installed simply by reversing the orientation of the bushing on the spindle relative to that shown in FIG. 2.

In the embodiments shown and described herein, disk portion 10 has a circular periphery having a diameter approximately equal to or greater than that of flanges 7 to help ensure optimum engagement therewith. However, the skilled artisan will recognize, in light of the instant disclosure, that disk portion 10 may be provided with a diameter less than that of the flanges 7, as long as some operative engagement is provided between disk portion 10 and one of the flanges 7. For example, in the configuration shown, the diameter of disk portion 10 may be as small as 70 percent or less than that of flanges 7 while still providing sufficient engagement therebetween.

In addition, although disk portion 10 is shown with a circular periphery, the skilled artisan should recognize that the disk portion may be provided with a periphery of substantially any shape, without departing from the spirit and scope of the present invention. For example, the disk portion may optionally be provided with a polygonal (e.g., octagonal) periphery as shown in phantom in FIG. 3.

Optimum peripheral dimensions of disk portion 10 may ultimately depend on the geometry of the particular flanges. For example, the peripheral geometry and dimensions, as well as the degree of concavity of the flanges of particular power saws, may affect the ability to obtain a secure engagement with a particular disk portion 10. Accordingly, to help ensure operability with as large a number of flanges as possible, it may be desirable to provide disk portion 10 with a transverse dimension predetermined to be greater than or equal to that of a majority of commonly available flanges. In this regard, particular embodiments may be provided with transverse dimensions of at least 70 percent that of flanges 7, and/or at least twice that of spindle 10.

Moreover, although embodiments of the invention are shown as engaged by peripheral portions of a flange 7, it should be recognized that these embodiments may be engaged by nominally any portion of flange(s) 7, including the radially inner concave portions thereof, such as by suitably increasing the axial dimension (e.g., thickness) of bushing 1, without departing from the spirit and scope of the present invention.

The following illustrative example is intended to demonstrate certain aspects of the present invention. It is to be understood that this example should not be construed as limiting.

### EXAMPLE

A bushing 1 was configured and used to secure a conventional saw blade 5 (NORTON™ PRO LINE, ZDH 500, 300 mm outside diameter, manufactured by Saint-Gobain Abrasives S.A., Bascharage, Luxembourg) to a spindle 6 of a power saw (STIHL™ TS760, manufactured by Andreas Stihl AG, Waiblingen, Germany) substantially as shown and described hereinabove with respect to FIGS. 1-3. The bushing 1 was fabricated from steel, having an inner diameter of 20.02 mm, and was mounted onto a 20 mm diameter spindle 6. The bushing included an annular shoulder 3 having an exterior diameter of 22.23 mm, which was received within a 22.25 mm aperture 2 of the saw blade 5. Disk portion 10 of the bushing had a diameter of about 103 mm to nominally match that of concave flanges 7. Flanges 7 were used to clamp bushing 1 and blade 5 to one another as shown and described hereinabove. The assembly was tested by cutting a concrete workpiece, wherein the bushing was found to successfully maintain the saw blade in concentric orientation with the spindle.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

Having thus described the invention, what is claimed is:

1. A saw blade assembly for concentrically fastening a circular saw blade having a relatively oversized central aperture, to a spindle of a rotary power tool, the assembly comprising:
a circular saw blade having a central aperture that is oversized relative to the spindle;
a bushing engaged with the saw blade;
the bushing including a disk having a central bore in engagement with the spindle, wherein the engagement is configured to substantially maintain concentricity of central bore with the spindle during operational rotation of the spindle about its central axis;
an annular shoulder disposed on a side of said disk, said annular shoulder received within the central aperture of the saw blade, wherein said receipt is configured to substantially maintain concentricity of the saw blade with the spindle during the operational rotation; and
said blade and said disk clamped in superposed orientation with one another between a pair of flanges disposed on the spindle.

2. The assembly of claim 1, comprising another annular shoulder disposed on another side of said disk, said other annular shoulder having another diameter sized for receipt within a central aperture of another saw blade.

3. The bushing of claim 1, wherein the disk has a transverse dimension sufficient to permit engagement by a peripheral portion of one of the flanges.

4. The bushing of claim 3, wherein the disk has a transverse dimension greater than or equal to that of at least one of the flanges.

5. A bushing for concentrically fastening a circular saw blade having a relatively oversized central aperture, to a spindle of a rotary power tool, the bushing comprising:
a disk having a central bore sized and shaped for engagement with the spindle, wherein said engagement substantially maintains concentricity of the central bore with the spindle during operational rotation of the spindle about its central axis;
an abutment disposed on one side of said disk, said abutment sized and shaped for receipt within a correspondingly sized and shaped recess of the saw blade, wherein said receipt substantially maintains concentricity of the saw blade with the spindle during the operational rotation; and
the disk configured for being engaged by a flange disposed on the spindle, wherein the disk is clamped on the spindle in superposed orientation with the saw blade.

6. The bushing of claim 5, further comprising the saw blade.

7. The bushing of claim 5, wherein said abutment comprises an annular shoulder.

8. The bushing of claim 7, wherein the recess comprises the central aperture of the saw blade.

9. The bushing of claim 8, comprising another annular shoulder disposed on another side of said disk, said other annular shoulder having another diameter sized for a sliding fit engagement within a central aperture of another saw blade.

10. The bushing of claim 5, wherein the disk has a transverse dimension sufficient to permit engagement by a peripheral portion of the flange.

11. The bushing of claim 10, wherein the disk has a transverse dimension greater than or equal to that of the flange.

12. The bushing of claim 10, wherein the disk has a transverse dimension of at least 70 percent that of the flange.

13. The bushing of claim 10, wherein the disk has a transverse dimension at least twice that of the central bore.

14. The bushing of claim 10, wherein the disk has a polygonal periphery.

15. The bushing of claim 10, wherein the disk has a circular periphery.

16. The bushing of claim 15, wherein the disk has an outer diameter greater than or equal to that of the flange.

17. The bushing of claim 15, wherein the disk has an outer diameter of at least 70 percent that of the flange.

18. The bushing of claim 15, wherein the disk has an outer diameter at least twice that of the central bore.

19. A method of securing a saw blade onto a spindle of a rotary power tool, the method comprising:
a. inserting the shoulder of a bushing of claim 5 into a central aperture of a circular saw blade to form a saw blade-bushing assembly;
b. placing the saw blade-bushing assembly onto the spindle of the power tool between opposing flanges; and
c. tightening the flanges towards one another wherein the assembly is secured on the machine shaft.

20. The method of claim 19, where said tightening is effected with a threaded fastener.

21. A bushing for concentrically fastening a circular saw blade having a relatively oversized central aperture, to a spindle of a rotary power tool, the bushing comprising:
disk means having a central bore sized and shaped for engagement with the spindle, wherein said engagement substantially maintains concentricity of the central bore with the spindle during operational rotation of the spindle about its central axis;
abutment means disposed on one side of said disk, said abutment means sized and shaped for receipt within a correspondingly sized and shaped recess of the saw blade, wherein said receipt substantially maintains concentricity of the saw blade with the spindle during the operational rotation;
the disk means adapted for engagement by a flange disposed on the spindle, wherein the disk means is clamped on the spindle in superposed orientation with the saw blade.
